(19) United States
(12) Patent Application Publication
(10) Pub. No.: US 2012/0314615 A1
(43) Pub. Date: Dec. 13, 2012

(54) BASE STATION APPARATUS AND TERMINAL APPARATUS WHICH TRANSMIT OR RECEIVE A SIGNAL INCLUDING INFORMATION

(75) Inventors: Makoto NAGAI, Kakamigahara-City (JP); Yoshio Yuse, Sumoto-City (JP); Ken Nakaoka, Ichinomiya-City (JP); Jun Yamasaki, Kobe-City (JP)

(73) Assignee: SANYO ELECTRIC CO., LTD.

(21) Appl. No.: 13/594,268

(22) Filed: Aug. 24, 2012

Related U.S. Application Data
(63) Continuation of application No. PCT/JP2011/053625, filed on Feb. 21, 2011.

(30) Foreign Application Priority Data
Feb. 26, 2010 (JP) 2010-043394
Feb. 26, 2010 (JP) 2010-043395
Feb. 18, 2011 (JP) 2011-033101

(51) Int. Cl. H04L 12/26; H04B 7/212

(52) U.S. Cl. 370/252; 370/347

(57) ABSTRACT

A base station apparatus controls inter-terminal communication. A frame in which a first period in which the base station apparatus may broadcast a signal, a second period in which the terminal apparatus may broadcast the signal, and a third period in which one-to-one transmission of the signal between the base station apparatus and the terminal apparatus may be performed are time-division multiplexed is defined. A processing unit generates information about a configuration of the frame. A modem unit and an RF unit broadcast the signal in which the generated information is included in the first period. The RF unit, the modem unit, and the processing unit receive the signal broadcasted from the terminal apparatus in the second period. The RF unit, the modem unit, and the processing unit perform one-to-one communication with the terminal apparatus in the third period.

### BACKGROUND OF THE INVENTION

1. Field of the Invention

The present invention relates to communication technology and especially relates to a base station apparatus and a terminal apparatus, which transmit/receive a signal including information.

2. Description of the Related Art

In order to prevent a collision accident at an intersection, road-to-vehicle communication has been studied. In the road-to-vehicle communication, information about a status of the intersection is communicated between a roadside unit and an in-vehicle apparatus. In the road-to-vehicle communication, it is required to install the roadside unit, so that time and cost increase. On the other hand, in inter-vehicle communication, that is to say, in a mode in which the information is communicated between the in-vehicle apparatuses, it is not required to install the roadside unit.

In this case, by detecting current positional information in real time by a global positioning system (GPS) and the like, for example, and exchanging the positional information between the in-vehicle apparatuses, it is judged on which road, which enters the intersection, its own vehicle and other vehicles are located.

An access control function referred to as carrier sense multiple access with collision avoidance (CSMA/CA) is used in a wireless local area network (LAN), which meets the IEEE802.11 standards and the like. Therefore, one wireless channel is shared by a plurality of terminal apparatuses in the wireless LAN. In such CSMA/CA, a status in which wireless signals of the terminal apparatuses do not reach each other by a distance therebetween and an effect of an obstacle, which attenuates an electric wave, that is to say, the status in which carrier sense does not act occurs. When the carrier sense does not act, packet signals transmitted from a plurality of terminal apparatuses collide with each other.

On the other hand, when the wireless LAN is applied to the inter-vehicle communication, it is required to transmit the information to a large indefinite number of terminal apparatuses, so that it is desired that the signal is broadcast-transmitted. However, at the intersection and the like, by increase in traffic due to increase in the number of vehicles, that is to say, increase in the number of terminal apparatuses, it is supposed that collision of the packet signals increases. As a result, data included in the packet signal is not transferred to another terminal apparatus. When such a state occurs in the inter-vehicle communication, an object to prevent the collision accident at the intersection is not achieved. Further, when the road-to-vehicle communication is executed in addition to the inter-vehicle communication, there are various communication modes. At that time, it is required to decrease a mutual effect between the inter-vehicle communication and the road-to-vehicle communication.

Further, in addition to the communication for preventing the collision accident of the vehicles, it is required to execute internet protocol (IP) communication such as an access to the Internet. At that time, the terminal apparatus accesses the Internet through the base station apparatus. In consideration of an original object of the above-described communication system, it may be said that importance of the IP communication is lower than the importance of the communication for preventing the collision accident of the vehicles. Therefore, it is also required to decrease the mutual effect between both of the communications.

### SUMMARY OF THE INVENTION

The present invention is achieved in view of such circumstances, and an object thereof is to provide the technology to decrease the mutual effect between the communications having a plurality of objects.

In order to solve the above-described problem, a base station apparatus according to one aspect of the present invention is a base station apparatus, which controls inter-terminal communication, comprising: a generating unit configured to define a frame in which a first period in which the base station apparatus may broadcast a signal, a second period in which a terminal apparatus may broadcast the signal, and a third period in which one-to-one transmission of the signal between the base station apparatus and the terminal apparatus may be performed are time-division multiplexed and to generate information about a configuration of the frame; a broadcasting unit configured to broadcast the signal in which the information generated by the generating unit is included in the first period; a receiving unit configured to receive the signal broadcasted from the terminal apparatus in the second period; and a communicating unit configured to perform one-to-one communication with the terminal apparatus in the third period.

Meanwhile, optional combination of the above-described components and those obtained by converting representation of the present invention to a method, a apparatus, a system, a recording medium, a computer program and the like also are effective as the aspect of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a view illustrating a configuration of a communication system according to an embodiment of the present invention;

FIG. 2 is a view illustrating a configuration of a base station apparatus in FIG. 1;

FIG. 3 is a view illustrating a first example of a format of a superframe defined in a communication system in FIG. 1;

FIG. 4 is a view illustrating a second example of the format of the superframe defined in the communication system in FIG. 1;

FIG. 5 is a view illustrating a third example of the format of the superframe defined in the communication system in FIG. 1;

FIG. 6 is a view illustrating a fourth example of the format of the superframe defined in the communication system in FIG. 1;

FIGS. 7A to 7C are views illustrating a fifth example of the format of the superframe defined in the communication system in FIG. 1;

FIGS. 8A and 8B are views illustrating a format of a MAC frame stored in a packet signal defined in the communication system in FIG. 1;

FIG. 9 is a view illustrating a data structure of a table stored in a processing unit in FIG. 2;

FIG. 10 is a view illustrating a configuration of a terminal apparatus mounted on a vehicle in FIG. 1;

FIG. 11 is a flowchart illustrating a selection procedure of a communication period of the terminal apparatus in FIG. 10;

FIG. 12 is a view illustrating a data structure of a table stored in the processing unit according to a modified example of the present invention; and

FIG. 13 is a view illustrating a data structure of another table stored in the processing unit according to the modified example of the present invention.

### DETAILED DESCRIPTION OF THE INVENTION

The invention will now be described by reference to the preferred embodiments. This does not intend to limit the scope of the present invention, but to exemplify the invention.

Before specifically describing the present invention, we describe an outline thereof. An embodiment of the present invention relates to a communication system, which executes inter-vehicle communication between terminal apparatuses mounted on vehicles and also executes road-to-vehicle communication from a base station apparatus installed at an intersection and the like to the terminal apparatus.

As the inter-vehicle communication, the terminal apparatus broadcast-transmits a packet signal in which information such as a speed, a position and the like of the vehicle (hereinafter, referred to as “data”) is stored. Also, another terminal apparatus receives the packet signal and recognizes approach and the like of the vehicle based on the data. The base station apparatus repeatedly defines a superframe. Herein, it is possible that a plurality of subframes are included or not included in the superframe. When a plurality of subframes are included in the superframe, the base station apparatus selects any one of a plurality of subframes and broadcast-transmits the packet signal in which control information and the like is stored in a period on a head part of the selected subframe.

The control information includes information about a period for the base station apparatus to broadcast-transmit the packet signal (hereinafter, referred to as a “road-to-vehicle transmission period”). The terminal apparatus specifies the road-to-vehicle transmission period based on the control information and transmits the packet signal in a period other than the road-to-vehicle transmission period.

In this manner, since the road-to-vehicle communication and the inter-vehicle communication are time-division multiplexed, collision probability of the packet signals of both of them is decreased. That is to say, interference between the road-to-vehicle communication and the inter-vehicle communication is decreased by recognition of contents of the control information by the terminal apparatus. Also, areas in which the terminal apparatus, which executes the inter-vehicle communication, is present are mainly classified into three types.

One of them is an area formed around the base station apparatus (hereinafter, referred to as a “first area”), another one is an area formed on the outside of the first area (hereinafter, referred to as a “second area”), and still another one is an area formed on the outside of the second area (hereinafter, referred to as an “outside of the second area”).

Herein, although the terminal apparatus may receive the packet signal from the base station apparatus with a certain level of quality in the first and second areas, the terminal apparatus cannot receive the packet signal from the base station apparatus with a certain level of quality on the outside of the second area.

Also, the first area is formed so as to be closer to the center of the intersection than the second area. The vehicle present in the first area is the vehicle present in the vicinity of the intersection, so that it may be said that the packet signal from the terminal apparatus mounted on this vehicle is important information in terms of inhibiting a collision accident.

In order to respond to this, a period for the inter-vehicle communication (hereinafter, referred to as an “inter-vehicle transmission period”) is formed by time-division multiplexing of a priority period and a general period. The priority period is the period used by the terminal apparatus present in the first area and the terminal apparatus transmits the packet signal in anyone of a plurality of slots, which form the priority period. Also, the general period is the period used by the terminal apparatus present in the second area and the terminal apparatus transmits the packet signal by a CSMA method in the general period. Meanwhile, the terminal apparatus present on the outside of the second area transmits the packet signal by the CSMA method irrespective of a configuration of the frame.

Further, it is also required that the terminal apparatus executes IP communication. As described above, it may be said that importance of the IP communication is lower than the importance of the inter-vehicle communication. Therefore, the collision probability of the packet signal for the former and the packet signal for the latter should be decreased.

In the communication system according to this embodiment, a period for executing the IP communication (hereinafter, referred to as an “IP period”) is defined in the superframe so as to be time-division multiplexed with the inter-vehicle transmission period and the road-to-vehicle transmission period. In the IP period, the base station apparatus and the terminal apparatus execute the IP communication.

Herein, although the terminal apparatus and the base station apparatus broadcast-transmit the packet signal in the inter-vehicle transmission period and the road-to-vehicle transmission period, the terminal apparatus and the base station apparatus unicast-transmit the packet signal in the IP period. Also, the base station apparatus adjusts a length of the IP period according to a traffic amount in the inter-vehicle transmission period. For example, when the traffic amount in the inter-vehicle transmission period increases, the length of the IP period is decreased. In this manner, the inter-vehicle communication has priority over the IP communication.

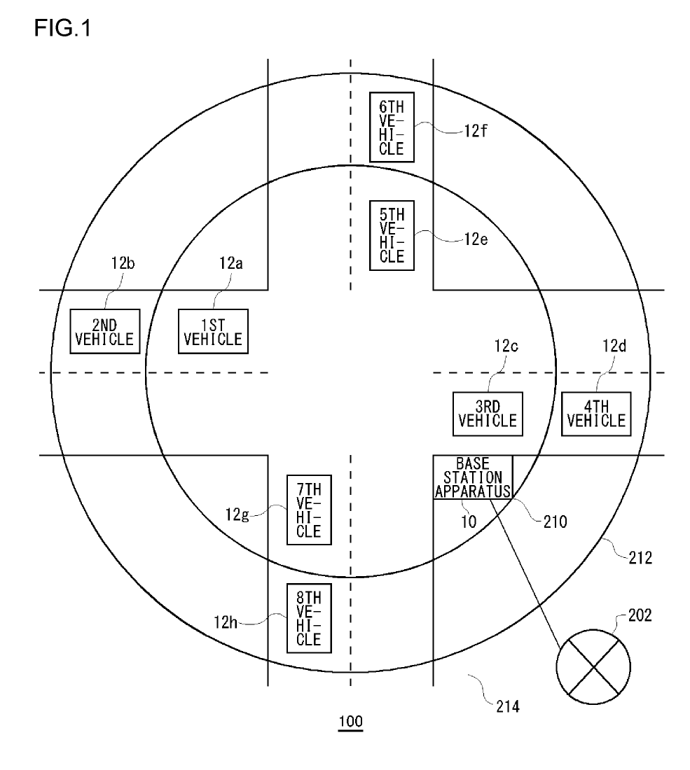

FIG. 1 illustrates a configuration of a communication system 100 according to the embodiment of the present invention. This corresponds to a case in which one intersection is seen from above. The communication system 100 includes a base station apparatus 10, a first vehicle 12a, a second vehicle 12b, a third vehicle 12c, a fourth vehicle 12d, a fifth vehicle 12e, a sixth vehicle 12f, a seventh vehicle 12g, and an eighth vehicle 12h collectively referred to as vehicles 12, and a network 202. Meanwhile, the terminal apparatus not illustrated is mounted on each vehicle 12. Also, a first area 210 is formed around the base station apparatus 10, a second area 212 is formed on the outside of the first area 210, and an outside of the second area 214 is formed on the outside area of the second area 212.

As illustrated, a road in a horizontal direction, that is to say, a right-left direction of the drawing and the road in a vertical direction, that is to say, an up-down direction of the drawing intersect with each other at a central portion. Herein, an upper side of the drawing corresponds to the “north”, a left side thereof corresponds to the “west”, a lower side thereof corresponds to the “south”, and a right side thereof corresponds to the “east”. Also, a portion at which the two roads intersect with each other is the “intersection”. The first and second vehicles 12a and 12b travel from left to right and third and fourth vehicles 12c and 12d travel from right to left. Also, the fifth and sixth vehicles 12e and 12f travel from above downward and the seventh and eighth vehicles 12g and 12h travel from below upward.

In the communication system 100, the base station apparatus 10 is arranged at the intersection and the base station apparatus 10 controls communication between the terminal apparatuses 14. The base station apparatus 10 repeatedly generates the superframe in which a plurality of subframes are included based on a signal received from a GPS satellite not illustrated and the superframe formed by another base station apparatus 10 not illustrated. Herein, it is defined such that the road-to-vehicle transmission period may be set on the head part of each subframe. The base station apparatus 10 selects the subframe in which the road-to-vehicle transmission period is not set by another base station apparatus 10 out of a plurality of subframes. The base station apparatus 10 sets the road-to-vehicle transmission period on the head part of the selected subframe. The base station apparatus 10 stores the control information in which the information about the road-to-vehicle transmission period and the like is included in the packet signal. The base station apparatus 10 also stores predetermined data in the packet signal. The base station apparatus 10 broadcasts the packet signal in the set road-to-vehicle transmission period.

Herein, the first area 210 and the second area 212 are formed around the communication system 100 according to a reception status at the time when the terminal apparatus receives the packet signal from the base station apparatus 10. As illustrated, the first area 210 is formed in the vicinity of the base station apparatus 10 as an area in which the reception status is relatively excellent. It also may be said that the first area 210 is formed in the vicinity of a central portion of the intersection. On the other hand, the second area 212 is formed on the outside of the first area 210 as the area in which the reception status is worse than that in the first area 210. Further, the outside of the second area 214 is formed on the outside area of the second area 212 as the area in which the reception status is further worse than that in the second area 212. Meanwhile, an error rate and received power of the packet signal are used as the reception status.

A plurality of terminal apparatuses receive the packet signal broadcasted by the base station apparatus 10 and estimate in which of the first area 210, the second area 212, and the outside of second area 214 they are present based on the reception status of the received packet signal. When it is estimated that the terminal apparatus is present in the first area 210 or the second area 212, this generates the superframe based on the control information included in the received packet signal. As a result, the superframe generated by each of a plurality of terminal apparatuses is synchronized with the frame generated by the base station apparatus 10. Also, the terminal apparatus recognizes the road-to-vehicle transmission period set by each base station apparatus 10 and specifies the inter-vehicle transmission period for transmitting the packet signal. Specifically, when the terminal apparatus is present in the first area 210, the priority period is specified and when this is present in the second area 212, the general period is specified. Further, the terminal apparatus broadcasts the packet signal by executing TDMA in the priority period and by executing CSMA/CA in the general period.

Meanwhile, the terminal apparatus selects the subframe having identical relative timing also in a next superframe. Especially, in the priority period, the terminal apparatus selects the slot having identical relative timing in the next superframe. Herein, the terminal apparatus obtains the data and stores the data in the packet signal. The data includes information about a present position, for example. The terminal apparatus also stores the control information in the packet signal. That is to say, the control information transmitted from the base station apparatus 10 is transferred by the terminal apparatus. On the other hand, when it is estimated that the terminal apparatus is present on the outside of the second area 214, this broadcasts the packet signal by executing the CSMA/CA irrespective of a configuration of the superframe.

Further, the terminal apparatus executes the IP communication between the same and the network 202 through the base station apparatus 10. As described above, it may be said that the IP communication is less important than the above-described communication for avoiding collision between the vehicles 12. Therefore, in order to decrease the interference between the communications, the IP period is provided in the frame generated by the base station apparatus 10 so as to be time-division multiplexed with the road-to-vehicle transmission period and the inter-vehicle transmission period. The base station apparatus 10 and the terminal apparatus perform one-to-one IP communication in the IP period.

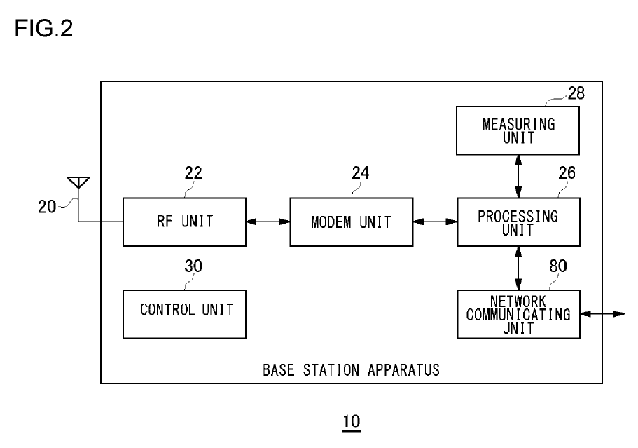

FIG. 2 illustrates a configuration of the base station apparatus 10. The base station apparatus 10 includes an antenna 20, an RF unit 22, a modem unit 24, a processing unit 26, a measuring unit 28, a control unit 30, and a network communicating unit 80. The RF unit 22 receives the packet signal from the terminal apparatus and another base station apparatus 10 not illustrated by the antenna 20 as a reception process. The RF unit 22 executes frequency conversion of a received packet signal at a radio frequency to generate a baseband packet signal. Further, the RF unit 22 outputs the baseband packet signal to the modem unit 24. In general, since the baseband packet signal is formed of an in-phase component and a quadrature component, two signal lines should be indicated; however, only one signal line is herein indicated so as to clarify the drawing. The RF unit 22 also includes a low noise amplifier (LNA), a mixer, an AGC, and an A/D converting unit.

The RF unit 22 executes the frequency conversion of the baseband packet signal input from the modem unit 24 as a transmission process to generate the packet signal at the radio frequency. Further, the RF unit 22 transmits the packet signal at the radio frequency from the antenna 20 in the road-to-vehicle transmission period. The RF unit 22 also includes a power amplifier (PA), the mixer, and a D/A converting unit.

The modem unit 24 executes demodulation of the baseband packet signal from the RF unit 22 as the reception process. Further, the modem unit 24 outputs a demodulated result to the processing unit 26. Also, the modem unit 24 executes modulation of the data from the processing unit 26 as the transmission process. Further, the modem unit 24 outputs a modulated result to the RF unit 22 as the baseband packet signal. Herein, the communication system 100 supports an orthogonal frequency division multiplexing (OFDM) modulation method, so that the modem unit 24 also executes fast Fourier transform (FFT) as the reception process and also executes inverse fast Fourier transform (IFFT) as the transmission process.

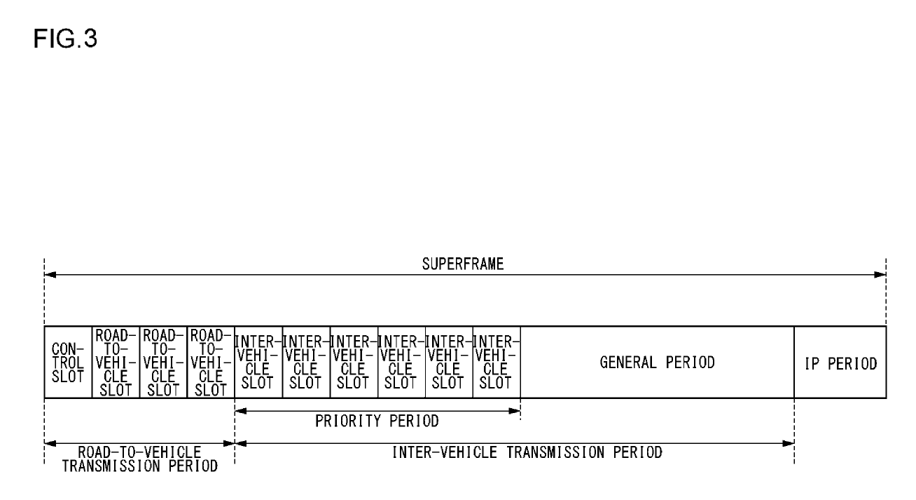

The processing unit 26 receives the demodulated result from another base station apparatus 10 not illustrated through the RF unit 22 and the modem unit 24. The processing unit 26 repeatedly generates the superframe formed with a predetermined period based on the demodulated result and the signal received from the GPS satellite. FIG. 3 illustrates a first example of a format of the superframe defined in the communication system 100. The superframe is defined to have the length of 10 msec, for example. The road-to-vehicle transmission period, the inter-vehicle transmission period, and the IP period are sequentially arranged from the head of the superframe. The road-to-vehicle transmission period is the period in which the base station apparatus 10 may broadcast the packet signal and a control slot and a plurality of road-to-vehicle slots are time-division multiplexed in the road-to-vehicle transmission period. In the control slot, the packet signal including the control information is broadcasted from the base station apparatus 10. In the road-to-vehicle slot, the packet signal including the data is transmitted from the base station apparatus 10.

The inter-vehicle transmission period is formed of the priority period and the general period. Both of them are the periods in which the terminal apparatus 14 may broadcast the packet signal. In the priority period, a plurality of inter-vehicle slots are time-division multiplexed. The priority period is the period, which should be used by the terminal apparatus present in the first area 210 in FIG. 1, and such terminal apparatus selects any one of the inter-vehicle slots and broadcasts the packet signal in the selected inter-vehicle slot. Also, the general period is the period, which should be used by the terminal apparatus present in the second area 212 in FIG. 1 and such terminal apparatus transmits the packet signal by executing the CSMA in the general period. By such a configuration, it may be said that a plurality of inter-vehicle slots, each of which might be used by one terminal apparatus 14, are arranged in the inter-vehicle transmission period and the general period, which might be shared by a plurality of terminal apparatuses 14, is arranged after a plurality of inter-vehicle slots. The IP period is the period in which one-to-one transmission of the packet signal between the base station apparatus 10 and the terminal apparatus may be performed.

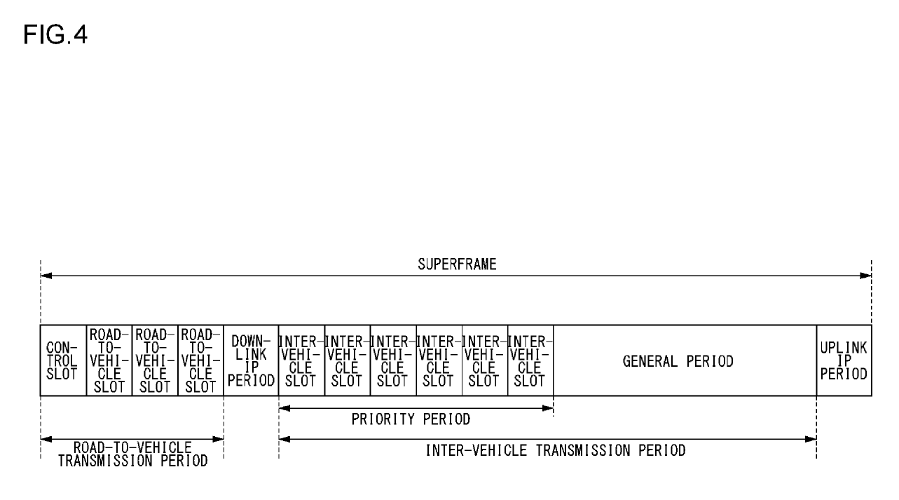

FIG. 4 illustrates a second example of the format of the superframe defined in the communication system 100. The road-to-vehicle transmission period, a downlink IP period, the inter-vehicle transmission period, and an uplink IP period are sequentially arranged from the head of the superframe. The road-to-vehicle transmission period and the inter-vehicle transmission period are similar to those in FIG. 3, so that the description thereof is herein omitted. The downlink IP period is the period in which the one-to-one transmission of the packet signal from the base station apparatus 10 to the terminal apparatus 14 may be performed between the road-to-vehicle transmission period and the inter-vehicle transmission period. Also, the uplink IP period is the period in which the one-to-one transmission of the packet signal from the terminal apparatus 14 to the base station apparatus 10 may be performed after the inter-vehicle transmission period. That is to say, in FIG. 4, the IP period in FIG. 3 is divided into the period dedicated for downlink and the period dedicated for uplink.

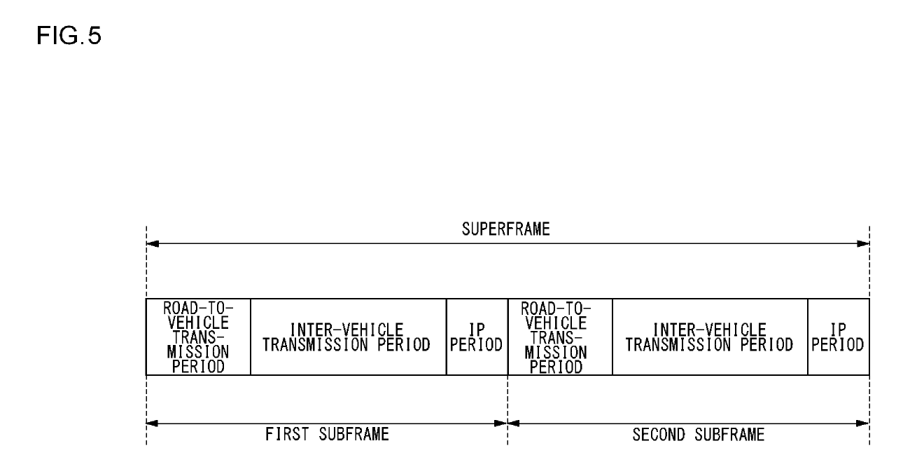

FIG. 5 illustrates a third example of the format of the superframe defined in the communication system 100. In the superframe, two subframes, which are first and second subframes, are time-division multiplexed. Meanwhile, the number of subframes included in one superframe is not limited to “two” and this may be a value not smaller than this. For example, when the length of the superframe is 100 msec and the number of subframes is 10, the subframes having the length of 10 msec are defined. Each subframe is configured just as the superframe in FIG. 3. Herein, one road-to-vehicle transmission period is occupied by one base station apparatus 10. On the other hand, one inter-vehicle transmission period is shared by a plurality of terminal apparatuses irrespective of the base station apparatus 10 around which they are present.

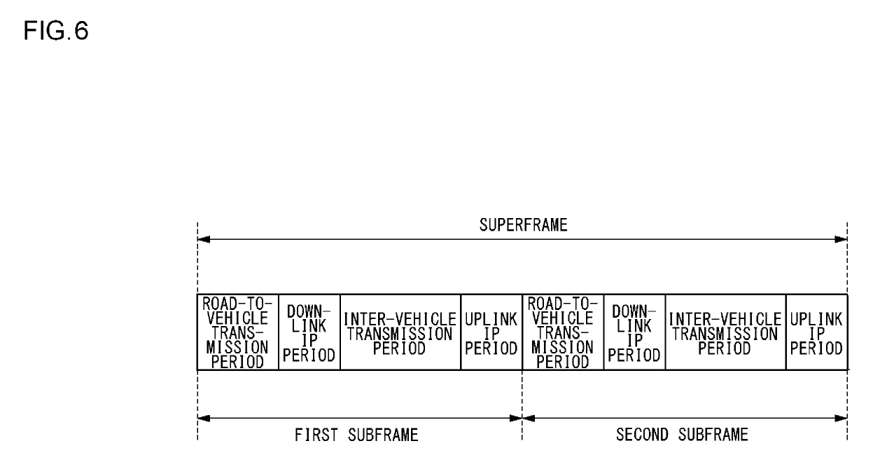

FIG. 6 illustrates a fourth example of the format of the superframe defined in the communication system 100. In the superframe, the two subframes, which are the first and second subframes, are time-division multiplexed. Meanwhile, the number of subframes included in one superframe is not limited to “two” and this may be the value not smaller than this. Each subframe is configured just as the superframe in FIG. 4. Herein, one road-to-vehicle transmission period is occupied by one base station apparatus 10. On the other hand, one inter-vehicle transmission period is shared by a plurality of terminal apparatuses irrespective of the base station apparatus 10 around which they are present.

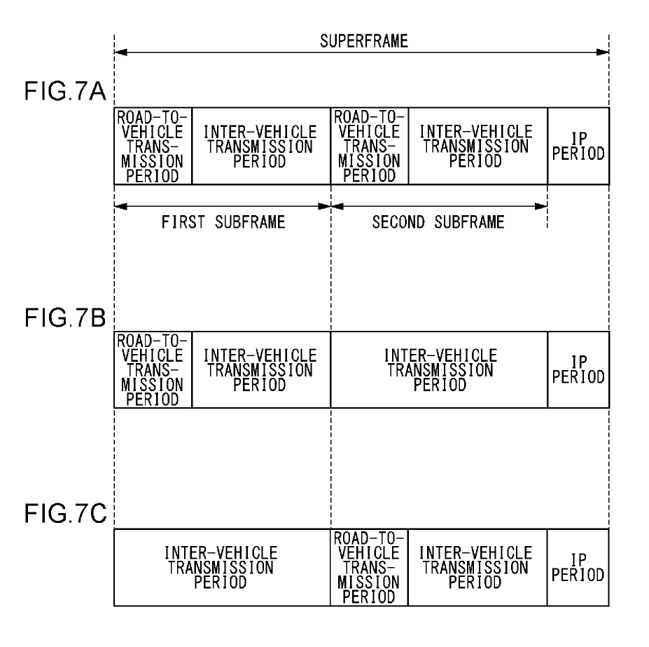

FIGS. 7A to 7C illustrate a fifth example of the format of the superframe defined in the communication system 100. In the superframe, the IP period is further time-division multiplexed after the two subframes, which are the first and second subframes, are time-division multiplexed. Meanwhile, the number of subframes included in one superframe is not limited to “two” and this may be the value not smaller than this. In each subframe, the road-to-vehicle transmission period and the inter-vehicle transmission period are time-division multiplexed.

FIG. 7B illustrates the configuration of the superframe generated by a first base station apparatus 10a. The first base station apparatus 10a sets the road-to-vehicle transmission period on the head part of the first subframe and sets the inter-vehicle transmission period following the same. Also, the first base station apparatus 10a sets the inter-vehicle transmission period in the second subframe. FIG. 7C illustrates the configuration of the superframe generated by a second base station apparatus 10b. The second base station apparatus 10b sets the road-to-vehicle transmission period on the head part of the second subframe and sets the inter-vehicle transmission period following the same. Also, the second base station apparatus 10b sets the inter-vehicle transmission period in the first subframe. In this manner, a plurality of base station apparatuses 10 select different subframes and set the road-to-vehicle transmission period on the head part of the selected subframe. Hereinafter, a case in which the superframe is composed of a plurality of subframes as in FIG. 5 to FIGS. 7A to 7C is mainly described. FIG. 2 is referred to again.

The processing unit 26 detects the control information from the demodulated result. The processing unit 26 specifies reception timing of the control information. The reception timing of the control information is the reception timing of the packet signal in which the control information is included, so that this corresponds to head timing of the subframe in which the road-to-vehicle transmission period is arranged. Also, the processing unit 26 obtains a subframe number included in the control information. Further, the superframe is generated based on the head timing of the subframe and the subframe number. Meanwhile, when the processing unit 26 receives the packet signal from a plurality of base station apparatuses 10, this selects the packet signal of which received power is the maximum and executes the above-described process to the selected packet signal. In this manner, the processing unit 26 generates the superframe synchronized with the superframe generated by another base station apparatus 10.

The processing unit 26 may execute a following process when this cannot receive the packet signal from another base station apparatus 10. The processing unit 26 receives the signal from the GPS satellite not illustrated and obtains information of time based on the received signal. Meanwhile, the well-known technology may be used for obtaining the information of time, so that the description thereof is herein omitted. The processing unit 26 generates a plurality of frames based on the information of time. For example, the processing unit 26 generates 10 superframes of “100 msec” by dividing a period of “1 sec” into 10 on the basis of the timing indicated by the information of time.

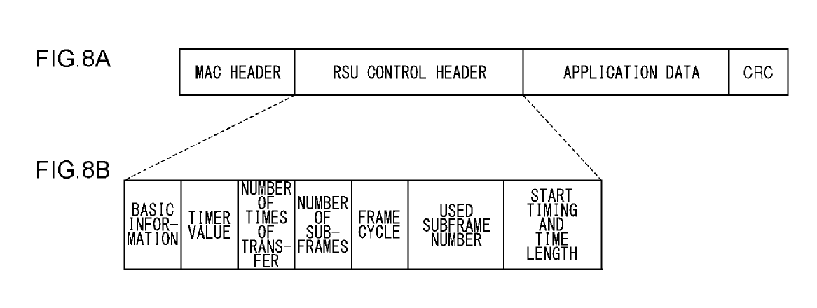

The processing unit 26 inputs the demodulated result from another base station apparatus 10 or the terminal apparatus not illustrated through the RF unit 22 and the modem unit 24. Herein, a configuration of a MAC frame stored in the packet signal is described as the demodulated result. Meanwhile, the configuration of the MAC frame input to the processing unit 26 and that of the MAC frame output from the processing unit 26 are similar to each other. FIGS. 8A and 8B illustrate a format of the MAC frame stored in the packet signal defined in the communication system 100. FIG. 8A illustrates the format of the MAC frame. In the MAC frame, a “MAC header”, an “RSU control header”, “application data”, and a “CRC” are sequentially arranged from the head thereof. The RSU control header corresponds to the above-described control information. The data, which should be notified to the terminal apparatus, such as accident information is stored in the application data.

FIG. 8B illustrates a format of the RSU control header. In the RSU control header, “basic information”, a “timer value”, a “number of times of transfer”, a “number of subframes”, a “frame cycle”, a “used subframe number”, and “start timing and time length” are sequentially arranged from the head thereof. Meanwhile, a configuration of the RSU control header is not limited to that in FIG. 8B and a part of elements may be eliminated or another element may be included. The number of times of transfer indicates the number of times that the control information transmitted from the base station apparatus 10, especially, the contents of the RSU control header are transferred by the terminal apparatus not illustrated. Herein, regarding the MAC frame output from the processing unit 26 to the modem unit 24, the base station apparatus 10 corresponds to this base station apparatus 10, and regarding the MAC frame input from the modem unit 24 to the processing unit 26, the base station apparatus 10 corresponds to another base station apparatus 10. This is common also in a following description.

Regarding the MAC frame output from the processing unit 26, the number of times of transfer is set to “0”. Also, regarding the MAC frame input from the modem unit 24 to the processing unit 26, the number of times of transfer is set to “one” or larger. The number of subframes indicates the number of subframes, which form one frame. The frame cycle indicates a cycle of the frame and this is set to “100 msec”, for example, as described above. The used subframe number is the number of the subframe in which the base station apparatus 10 sets the inter-vehicle transmission period. As illustrated in FIG. 8A, the subframe number is set to “one” on the head of the frame. In the start timing and time length, the start timing of the road-to-vehicle transmission period on the head of the subframe and the time length of the road-to-vehicle transmission period are indicated. FIG. 2 is referred to again.

The processing unit 26 extracts the MAC frame in which the number of times of transfer is set to “0” out of the MAC frames. This corresponds to the packet signal directly transmitted from another base station apparatus 10. The processing unit 26 specifies a value of the used subframe number from the extracted MAC frame. This corresponds to specification of the subframe used by another base station apparatus 10. The processing unit 26 measures the received power of the packet signal received by the RF unit 22 in units of packet signal. Also, the processing unit 26 extracts the received power of the packet signal arranged on the head of the already specified subframe. This corresponds to extraction of the received power of the packet signal from another base station apparatus 10.

The processing unit 26 extracts the MAC frame in which the number of times of transfer is set to “one” or larger out of the MAC frames input to the processing unit 26. This corresponds to the packet signal transferred by the terminal apparatus after being transmitted from another base station apparatus 10. The processing unit 26 specifies the value of the used subframe number from the extracted MAC frame. This corresponds to the specification of the subframe used by another base station apparatus 10. Meanwhile, the terminal apparatus transfers the subframe number at the time when the terminal apparatus receives the packet signal from another base station apparatus 10.

The processing unit 26 measures the received power of the packet signal. Also, the processing unit 26 estimates that a measured received power is the received power of the packet signal from another base station apparatus 10 of which control information is transferred by this packet signal. The processing unit 26 specifies the subframe in which the road-to-vehicle transmission period should be set. Specifically, the processing unit 26 confirms whether there is an “unused” subframe. When this is present, the processing unit 26 selects any one of the “unused” subframes. Herein, when a plurality of subframes are not used, the processing unit 26 randomly selects one subframe. When there is no unused subframe, that is to say, when each of a plurality of subframes is used, the processing unit 26 preferentially specifies the subframe with small received power.

The processing unit 26 sets the road-to-vehicle transmission period on the head part of the subframe having the specified subframe number. The processing unit 26 generates the MAC frame, which should be stored in the packet signal. At that time, the processing unit 26 determines a value of the RSU control header of the MAC frame according to setting of the road-to-vehicle transmission period.

The modem unit 24 and the RF unit 22 broadcast the packet signal in which the control information generated by the processing unit 26 is included in the control slot in the road-to-vehicle transmission period. Also, the modem unit 24 and the RF unit 22 broadcast the packet signal in which the data generated by the processing unit 26 is included in the road-to-vehicle slot in the road-to-vehicle transmission period. The modem unit 24 and the RF unit 22 broadcast the packet signal in which the control information and the data generated by a generating unit 64 are included in the road-to-vehicle transmission period of any one of a plurality of subframes included in the superframe in FIG. 5 to FIGS. 7A to 7C.

In the inter-vehicle transmission period, the RF unit 22 and the modem unit 24 receive the packet signal broadcasted from the terminal apparatus. Also, in the road-to-vehicle transmission period of another base station apparatus 10, the RF unit 22 and the modem unit 24 receive the packet signal broadcasted from the other base station apparatus 10. The modem unit 24 and the RF unit 22 perform one-to-one communication with the terminal apparatus in the IP period in FIGS. 3, 5, and FIGS. 7A to 7C. The modem unit 24 and the RF unit 22 performs the one-to-one transmission of the packet signal to the terminal apparatus in the downlink IP period in FIGS. 4 and 6 and performs one-to-one reception of the packet signal from the terminal apparatus in the uplink IP period in FIGS. 4 and 6.

The measuring unit 28 measures the traffic amount in the inter-vehicle transmission period. Specifically described, the measuring unit 28 measures a period in which the packet signal is broadcasted in the inter-vehicle transmission period based on the packet signal received by the processing unit 26. The measurement may be performed across a plurality of superframes. In addition to this, the measuring unit 28 may measure the number of packet signals broadcasted in the inter-vehicle transmission period based on the packet signal received by the processing unit 26. The measuring unit 28 outputs the traffic amount to the processing unit 26.

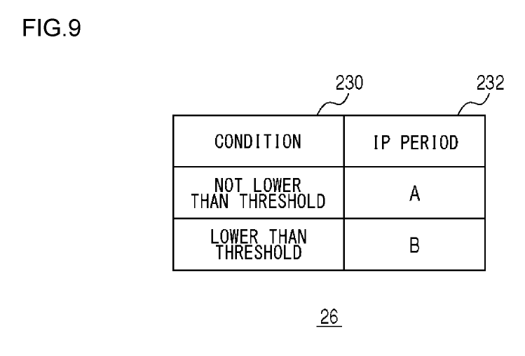

The processing unit 26 receives the traffic amount from the measuring unit 28. FIG. 9 illustrates a data structure of a table stored in the processing unit 26. As illustrated, a condition field 230 and an IP period field 232 are included. In the condition field 230, a condition for a threshold, which should be compared with the traffic amount, is indicated. In the IP period field 232, the length of the IP period when the condition indicated in the condition field 230 is satisfied is indicated. Herein, suppose that A<B is satisfied. Meanwhile, it is possible that a plurality of thresholds and three or more periods are defined. FIG. 2 is referred to again.

The processing unit 26 compares the traffic amount measured by the measuring unit 28 with the threshold indicated in FIG. 9, thereby adjusting the length of the IP period. Herein, the larger the traffic amount is, the shorter the IP period is made. Also, when the superframes in FIGS. 4 and 6 are used, the processing unit 26 adjusts at least one of the length of the downlink IP period and the length of the uplink IP period according to the traffic amount measured by the processing unit 26 and the threshold. It is possible to adjust both of them. Also, it is possible that the length of the downlink IP period and the length of the uplink IP period are different from each other. The processing unit 26 includes the length of the IP period or the length of the downlink IP period and the length of the uplink IP period in the control signal. Specifically described, the processing unit 26 includes information about the length of the IP period in the RSU control header or the application data in FIG. 8A.

The processing unit 26 obtains predetermined information through the network communicating unit 80 and includes the predetermined information in the application data. Herein, the network communicating unit 80 is connected to the network 202 not illustrated. The processing unit 26 allows the modem unit 24 and the RF unit 22 to transmit the packet signal in the road-to-vehicle transmission period. The control unit 30 controls a process of an entire base station apparatus 10.

Although this configuration may be realized by a CPU, memory, and another LSI of an optional computer in a hardware aspect and is realized by a program loaded on the memory and the like in a software aspect, a functional block realized by cooperation of them is herein illustrated. Therefore, one skilled in the art may comprehend that the functional block may be realized in various modes only by hardware, only by software, or by combination of them.

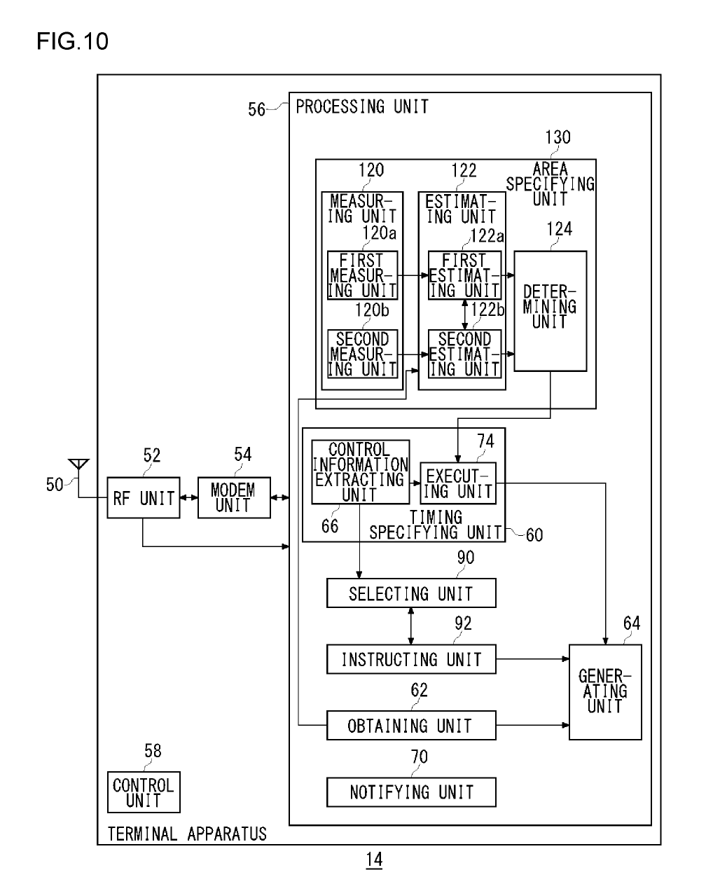

FIG. 10 illustrates a configuration of the terminal apparatus 14 mounted on the vehicle 12. That is to say, the terminal apparatus 14 might be moved. The terminal apparatus 14 includes an antenna 50, an RF unit 52, a modem unit 54, a processing unit 56, and a control unit 58. Also, the processing unit 56 includes an area specifying unit 130, a timing specifying unit 60, an obtaining unit 62, the generating unit 64, a notifying unit 70, a selecting unit 90, and an instructing unit 92. The area specifying unit 130 includes a first measuring unit 120a and a second measuring unit 120b collectively referred to as measuring units 120, a first estimating unit 122a and a second estimating unit 122b collectively referred to as estimating units 122, and a determining unit 124, and the timing specifying unit 60 includes a control information extracting unit 66 and an executing unit 74. The antenna 50, the RF unit 52, and the modem unit 54 execute processes similar to those of the antenna 20, the RF unit 22, and the modem unit 24 in FIG. 2. Therefore, the description thereof is herein omitted.

The modem unit 54 and the processing unit 56 receive the packet signal from the base station apparatus 10. Meanwhile, as described above, the subframe in which the priority period and the general period are time-division multiplexed is defined. The priority period is the period, which should be used by the terminal apparatus 14 present in the first area 210 formed around the base station apparatus 10 for transmitting the packet signal. The general period is the period, which should be used by the terminal apparatus 14 present in the second area formed on the outside of the first area 210 for transmitting the packet signal. Also, the superframe in which a plurality of subframes are time-division multiplexed is defined.

The first measuring unit 120a measures the received power of the received packet signal. The well-known technology may be used as a method of measuring the received power, so that the description thereof is herein omitted. Meanwhile, the first measuring unit 120a may measure an SNR, an SIR and the like in place of the received power. The first measuring unit 120a outputs the measured received power to the first estimating unit 122a. The second measuring unit 120b measures the error rate of the received packet signal. A bit error rate (BER), a packet error rate (PER) and the like are measured, for example, as the error rate. The second measuring unit 120b outputs the measured error rate to the second estimating unit 122b. In this manner, the measuring unit 120 measures the quality of the received packet signal.

The first estimating unit 122a estimates whether the terminal apparatus is present in the first area 210 or in the second area 212 based on the received power measured by the first measuring unit 120a. The second estimating unit 122b estimates whether the terminal apparatus is present in the second area 212 or on the outside of the second area 214 based on the error rate measured by the second measuring unit 120b. As a result, the first estimating unit 122a and the second estimating unit 122b estimate in which of the first area 210, the second area 212, and the outside of the second area 214 the terminal apparatus is present in cooperation with each other. A specific process of estimation is to be described later. Meanwhile, the number of errors may be used in place of the error rate. The first estimating unit 122a and the second estimating unit 122b output estimated results to the determining unit 124.

The determining unit 124 determines any one of the priority period, the general period, and timing, which is not related to the configuration of the frame, as the transmission period based on at least one of the estimated result by the second estimating unit 122b and the estimated result by the first estimating unit 122a. Specifically described, when the second estimating unit 122b estimates presence on the outside of the second area 214, the determining unit 124 selects the timing, which is not related to the configuration of the frame. When the first and second estimating units 122a and 122b estimate the presence in the second area 212, the determining unit 124 selects the general period. When a estimating unit 122a estimates the presence in the first area 210, the determining unit 124 selects the priority period. The modem unit 24 outputs a selected result to the executing unit 74.

Herein, an estimation process of the area by the first and second estimating units 122a and 122b is described. First, the estimation process between the outside of the second area 214 and the second area 212 is described. The second estimating unit 122a estimates entry from the outside of the second area 214 to the second area 212 when it transits from a state in which the error rate is higher than the threshold to a state in which the error rate is not higher than the threshold. Herein, the state in which the error rate is higher than the threshold corresponds to the presence on the outside of the second area 214 and the state in which the error rate is not higher than the threshold corresponds to the presence in the second area 212. When the terminal apparatus is present on the outside of the second area 214, the first estimating unit 122a stops estimating. On the other hand, when the second estimating unit 122b estimates the entry to the second area 212, the first estimating unit 122a starts estimating.

When the first and second estimating units 122a and 122b estimate the presence in the second area, the second estimating unit 122b estimates escape from the second area 212 to the outside of the second area 214 when it transits from the state in which the error rate is not higher than the threshold to the state in which the error rate is higher than the threshold. Herein, the case in which the second estimating unit 122b estimates the presence in the second area 212 is the above-described state and the case in which the first estimating unit 122a estimates the presence in the second area 212 will be described later. When the second estimating unit 122b estimates the escape to the outside of the second area 214, the first estimating unit 122a stops estimating.

Herein, the second estimating unit 122b does not immediately estimate the entry to the second area 212 even when it transits from the state in which the error rate is higher than the threshold to the state in which the error rate is not higher than the threshold. When it is in the state in which the error rate is not higher than the threshold in a plurality of consecutive frames, the second estimating unit 122b estimates the entry to the second area 212. For example, the number of frames required is set as “three”. Herein, a condition for moving to the area closer to the base station apparatus 10 is referred to as a “first condition” and the first condition for moving from the outside of the second area 214 to the second area 212 is that the “error rate is not higher than the threshold in three consecutive frames from the state in which the error rate is higher than the threshold”.

On the contrary, a condition for moving to the area away from the base station apparatus 10 is referred to as a “second condition”. For example, the second condition for moving from the second area 212 to the outside of the second area 214 is that “the error rate is higher than the threshold in five consecutive frames from the state in which the error rate is not higher than the threshold”. In this manner, the second estimating unit 122b estimates the entry from the outside of the second area 214 to the second area 212 when the measured error rate is improved to satisfy the first condition and estimates the entry from the second area 212 to the outside of second area 214 when the measured error rate is deteriorated to satisfy the second condition.

Next, the estimation process between the second area 212 and the first area 210 is described. When the first and second estimating units 122a and 122b estimate the presence in the second area 212, the first estimating unit 122a estimates the entry from the second area 212 to the first area 210 when it transits from a state in which the received power is lower than the threshold to a state in which the received power is not lower than the threshold. Herein, the state in which the received power is lower than the threshold corresponds to the presence in the second area 212 and the state in which the received power is not lower than the threshold corresponds to the presence in the first area 210. When the first estimating unit 122a estimates the entry to the first area 210, the second estimating unit 122b stops estimating.

The first estimating unit 122a estimates the entry from the first area 210 to the second area 212 when it transits from the state in which the received power is not lower than the threshold to the state in which the received power is lower than the threshold. The second estimating unit 122b stops estimating when the terminal apparatus is present in the first area 210. The second estimating unit 122b starts estimating when the first estimating unit 122a estimates the entry to the second area 212. As with the second estimating unit 122b, the first estimating unit 122a also sets the first and second conditions for the movement between the first area 210 and the second area 212. In this manner, the first estimating unit 122a estimates the entry from the second area 212 to the first area 210 when the measured received power is improved to satisfy the first condition and estimates the entry from the first area 210 to the second area 212 when the measured received power is deteriorated to satisfy the second condition.

The obtaining unit 62 includes a GPS receiver, a gyroscope, a vehicle speed sensor and the like not illustrated and obtains the present position, a travel direction, a moving speed and the like of the vehicle 12 not illustrated, that is to say, the vehicle 12 on which the terminal apparatus 14 is mounted by the data supplied therefrom. Meanwhile, the present position is indicated by latitude and longitude. The well-known technology may be used for obtaining them, so that the description thereof is herein omitted. The obtaining unit 62 outputs the obtained information to the generating unit 64.

The control information extracting unit 66 receives the packet signal from the RF unit 52 or the demodulated result from the modem unit 54. Also, when the demodulated result is the packet signal from the base station apparatus 10 not illustrated, the control information extracting unit 66 specifies the timing of the subframe in which the road-to-vehicle transmission period is arranged. Also, the control information extracting unit 66 generates the superframe based on the timing of the subframe and the contents of the RSU control header. Meanwhile, the superframe may be generated as in the above-described processing unit 26, so that the description thereof is herein omitted. As a result, the control information extracting unit 66 generates the frame synchronized with the frame formed by the base station apparatus 10. Also, the control information extracting unit 66 specifies the road-to-vehicle transmission period based on the contents of the RSU control header.

Further, the control information extracting unit 66 selects anyone of a plurality of subframes and specifies a period other than the road-to-vehicle transmission period and the IP period of the selected subframe as the inter-vehicle transmission period. Specifically, a part of the inter-vehicle transmission period is specified as the priority period and the remainder of the inter-vehicle transmission period is specified as the general period. For example, the length of the priority period is determined in advance and the length of the general period is derived by subtracting the priority period from the inter-vehicle transmission period. The control information extracting unit 66 outputs the timings of the frame and the subframe and information about the inter-vehicle transmission period to the executing unit 74.

The executing unit 74 receives the information about the transmission period from the determining unit 124. The executing unit 74 selects any one of the priority period, the general period, and the timing, which is not related to the configuration of the frame, based on the information about the transmission period. Also, the executing unit 74 inputs the timings of the frame and the subframe and the information about the inter-vehicle transmission period from the control information extracting unit 66. The executing unit 74 recognizes the timings of the frame and the subframe, the priority period, and the general period based on them. When the executing unit 74 selects the priority period, this selects anyone of the slots included in the priority period. For example, the slot with the lowest received power is selected. The executing unit 74 determines the selected slot as transmission timing.

When the executing unit 74 selects the general period, this executes the CSMA in the general period. Specifically described, the executing unit 74 measures interference power by executing carrier sense. Also, the executing unit 74 determines the transmission timing based on the interference power. Specifically described, the executing unit 74 stores a predetermined threshold in advance and compares the interference power with the threshold. When the interference power is lower than the threshold, the executing unit 74 determines the transmission timing. When the executing unit 74 selects the timing, which is not related to the configuration of the frame, this determines the transmission timing by executing the CSMA without consideration of the configuration of the frame. The executing unit 74 notifies the generating unit 64 of the determined transmission timing.

The generating unit 64 generates the data so as to include the information obtained by the obtaining unit 62. At that time, the MAC frame illustrated in FIGS. 8A and 8B is used, and the generating unit 64 stores the measured present position in the application data. The generating unit 64 broadcast-transmits the packet signal in which the data is included through the modem unit 54, the RF unit 52, and the antenna 50 at the transmission timing determined by the executing unit 74. The notifying unit 70 obtains the packet signal from the base station apparatus 10 not illustrated in the road-to-vehicle transmission period and obtains the packet signal from another terminal apparatus 14 not illustrated in the inter-vehicle transmission period. The notifying unit 70 notifies a driver of the approach and the like of another vehicle 12 not illustrated by means of a monitor and a speaker according to the contents of the data stored in the packet signal.

The control information extracting unit 66 extracts the information about the length of the IP period from the RSU control header or the application data of the MAC frame, thereby specifying the IP period. The RF unit 52, the modem unit 54, and the processing unit 56 execute the IP communication in the specified IP period. On the other hand, in a case of the formats of the superframe in FIGS. 4 and 6, the RF unit 52, the modem unit 54, and the processing unit 56 receive the packet signal for the IP communication in the downlink IP period. Also, the processing unit 56, the modem unit 54, and the RF unit 52 transmit the packet signal for the IP communication in the uplink IP period.

Hereinafter, transfer of the RSU control header by the terminal apparatus 14 is described. The control information extracting unit 66 extracts the RSU control header from the packet signal of which information source is the base station apparatus 10. As described above, although the number of times of transfer is set to “0” when the packet signal is directly transmitted from the base station apparatus 10, the number of times of transfer is set to a value “not smaller than one” when the packet signal is transmitted from another terminal apparatus 14. Herein, the used subframe number is not changed when this is transferred by the terminal apparatus 14, so that the subframe used by the base station apparatus 10, which is the information source, is specified by reference to the used subframe number.

The selecting unit 90 obtains information about the number of times of transfer for each base station apparatus 10, which is the information source. The selecting unit 90 selects the control information corresponding to at least one base station apparatus 10 as the control information, which should be transferred, based on the number of times of transfer. Meanwhile, the information other than the number of times of transfer may be used in selection. The instructing unit 92 instructs the processing unit 26 to generate the RSU control header based on the control information selected by the selecting unit 90. The instructing unit 92 increments the number of times of transfer in the information about the number of times of transfer when storing the control information in the RSU control header. The generating unit 64 generates the RSU control header based on the control information selected by the selecting unit 90 according to such instruction and increments the number of times of transfer at that time. Meanwhile, the instructing unit 92 notifies the selecting unit 90 of the fact that the number of times of transfer is incremented. The control unit 58 controls operation of the entire terminal apparatus 14.

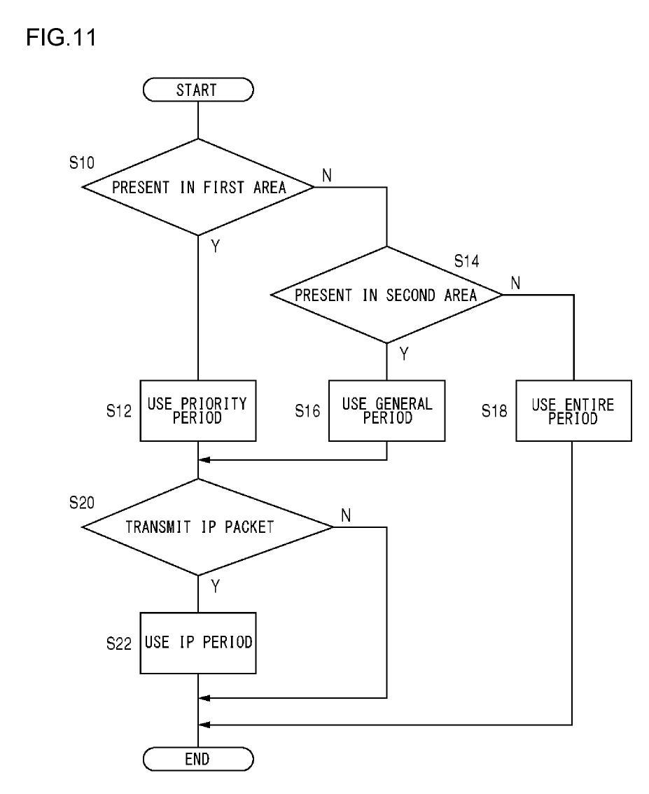

Operation of the communication system 100 by the above-described configuration is described. FIG. 11 is a flowchart illustrating a selection procedure of a communication period by the terminal apparatus 14. When the terminal apparatus is present in the first area 210 (Y at S10), the timing specifying unit 60 uses the priority period (S12). When the terminal apparatus is not present in the first area 210 (N at S10) and is present in the second area 212 (Y at S14), the timing specifying unit 60 uses the general period (S16). Also, when the IP communication is executed (Y at S20), the timing specifying unit 60 uses the IP period (S22). On the other hand, when the IP communication is not executed (N at S20), the timing specifying unit 60 skips the step S22. When the terminal apparatus is not present in the second area 212 (N at S14), the timing specifying unit 60 uses an entire period (S18).

Next, a modified example of the present invention is described. The modified example of the present invention relates to the communication system, which executes the inter-vehicle communication between the terminal apparatuses mounted on the vehicles and also executes the road-to-vehicle communication from the base station apparatus installed at the intersection and the like to the terminal apparatus, as in the embodiment. When the length of the IP period is changed for each superframe, the terminal apparatus often understands the length of the IP period with delay. Therefore, the timing understood by the terminal apparatus as the IP period might be the inter-vehicle transmission period. When the terminal apparatus transmits the packet signal for the IP communication at that timing, the packet signal for the IP communication and the packet signal for the inter-vehicle communication collide with each other more easily. As a result, there is an adverse effect on the inter-vehicle communication. In order to deal with this, the communication system according to this embodiment changes the length of the IP period for each plurality of superframes. Also, the number of superframes with which the length of the IP period should be changed is changed according to a degree of variation in the traffic amount. The communication system 100 and the base station apparatus 10 according to the modified example of the present invention are of the type similar to those in FIGS. 1 and 2. Difference is hereinafter mainly described.

The measuring unit 28 measures an average value of the traffic amount in the inter-vehicle transmission period. Specifically described, the measuring unit 28 measures a period in which the packet signal is broadcasted in the inter-vehicle transmission period based on the packet signal received by the processing unit 26. The measurement is performed across a plurality of superframes and the average value of the traffic amount is derived by dividing a measured result by the number of superframes. Also, the measuring unit 28 measures an amount of variation in the traffic amount in the inter-vehicle transmission period. The amount of variation is derived by calculating dispersion based on the period in which the packet signal is broadcasted in the inter-vehicle transmission period and the average value of the traffic amount. In addition to this, the average value and the amount of variation in the traffic amount may be derived based on the number of packet signals broadcasted in the inter-vehicle transmission period. The measuring unit 28 outputs the average value and the amount of variation in the traffic amount to the processing unit 26.

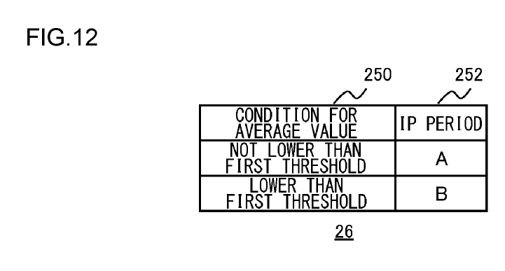

The processing unit 26 receives the average value and the amount of variation in the traffic amount from the measuring unit 28. FIG. 12 illustrates a data structure of a table stored in the processing unit 26. As illustrated, a condition for average value field 250 and an IP period field 252 are included. A condition for a threshold, which should be compared with the average value of the traffic amount, is indicated in the condition for average value field 250. The threshold is herein set as a first threshold. In the IP period field 252, the length of the IP period when the condition indicated in the condition for average value field 250 is satisfied is indicated. Herein, suppose that A<B is satisfied. Meanwhile, it is possible that a plurality of thresholds and the IP periods of three or more lengths are defined. FIG. 2 is referred to again.

The processing unit 26 compares the average value of the traffic amount measured by the measuring unit 28 with the first threshold indicated in FIG. 12, thereby adjusting the length of the IP period. Herein, the larger the average value of the traffic amount is, the shorter the IP period is made. Also, when the superframes in FIGS. 4 and 6 are used, the processing unit 26 adjusts at least one of the length of the downlink IP period and the length of the uplink IP period according to the average value of the traffic amount measured by the processing unit 26 and the first threshold. It is possible to adjust both of them. Also, it is possible that the length of the downlink IP period and the length of the uplink IP period are different from each other.

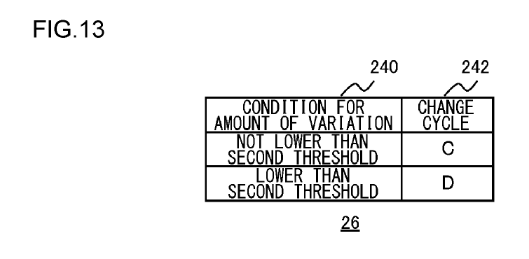

FIG. 13 illustrates a data structure of another table stored in the processing unit 26. As illustrated, a condition for amount of variation field 240 and a change cycle field 242 are included. A condition for a threshold, which should be compared with the amount of variation in the traffic amount, is indicated in the condition for amount of variation field 240. The threshold is herein set as a second threshold. A change cycle when the condition indicated in the condition for amount of variation field 240 is satisfied is indicated in the change cycle field 242. The change cycle is intended to mean the cycle of change of the length of the IP period. Herein, suppose that C<D is satisfied. Meanwhile, it is possible that a plurality of thresholds and the change cycles of three or more lengths are defined. FIG. 2 is referred to again.

The processing unit 26 determines the change cycle by comparing the amount of variation in the traffic amount measured by the measuring unit 28 and the second threshold indicated in FIG. 13. This corresponds to determination of the number of superframes in which the length of the IP period is fixed according to the amount of variation in the traffic amount measured by the measuring unit 28. That is to say, the length of the IP period is fixed across a plurality of superframes until the change cycle comes. Herein, the larger the amount of variation in the traffic amount is, the shorter the change cycle is made. That is to say, the larger the amount of variation in the traffic amount is, the smaller the number of superframes in which the length of the IP period is fixed is made. Meanwhile, an adjustment process of the length of the IP period described above may be executed at timing at which the change cycle comes. Also, when the superframes in FIGS. 4 and 6 are used, the processing unit 26 determines the number of superframes in which at least one of the length of the downlink IP period and the length of the uplink IP period is fixed according to the amount of variation in the traffic amount measured by the processing unit 26 and the second threshold. It is possible that the lengths of both of the IP periods are adjusted.

The processing unit 26 includes the length of the IP period or the length of the downlink IP period and the length of the uplink IP period in the control signal. Specifically described, the processing unit 26 includes the information about the length of the IP period in the RSU control header or the application data in FIG. 8A. The information of the length of the IP period included in the control signal is fixed across the superframes as many as the number corresponding to the change cycle. When the change cycle comes, the information of the length of the IP period might be changed.

The terminal apparatus 14 according to the modified example of the present invention is of the type similar to that in FIG. 10. Difference is hereinafter mainly described. The control information extracting unit 66 extracts the information about the length of the IP period from the RSU control header or the application data of the MAC frame, thereby specifying the IP period. Herein, the information about the length of the IP period is identical across the superframes as many as the number corresponding to the change cycle. The RF unit 52, the modem unit 54, and the processing unit 56 execute the IP communication in the specified IP period. On the other hand, in the case of the formats of the superframes in FIGS. 4 and 6, the RF unit 52, the modem unit 54, and the processing unit 56 receive the packet signal for the IP communication in the downlink IP period. Also, the processing unit 56, the modem unit 54, and the RF unit 52 transmit the packet signal for the IP communication in the uplink IP period.

According to the embodiment of the present invention, since the period of the IP communication is provided separately from the period of the inter-vehicle communication and the period of the road-to-vehicle communication, the interference between the IP communication and another communication may be decreased. Therefore, it is possible to decrease a mutual effect between the communications having a plurality of objects. Also, since the interference between the IP communication and another communication is decreased, it is possible to execute the IP communication while decreasing the effect on the inter-vehicle communication and the road-to-vehicle communication. Also, since the IP communication may be executed, it is possible to transmit/receive the information by the IP communication also by the vehicle. Also, since the IP communication period and the general period are continuous and the IP period and the priority period are not continuous, it is possible to further decrease the effect by the packet signal of the IP communication in the priority period than in the general period. Also, since the effect by the packet signal of the IP communication is further decreased in the priority period than in the general period, the information of which importance is higher may be protected.

Also, since the uplink IP period and the downlink IP period are separately set, it is possible to decrease the interference between the packet signal for the uplink IP communication and the packet signal for the downlink IP communication. Also, since the downlink IP period and the road-to-vehicle transmission period are continuous, it is possible to efficiently output the packet signal from the base station apparatus. Also, since a plurality of subframes are set in one superframe, it is possible to decrease the interference between the packet signals broadcasted from a plurality of base station apparatuses. Also, since the IP period is adjusted according to the traffic amount of the inter-vehicle communication, it is possible to make the priority of the inter-vehicle communication higher than that of the IP communication. Also, the larger the traffic amount is, the shorter the IP period is made, so that it is possible to inhibit the collision probability of the packet signals of the inter-vehicle communication from increasing.

Since the error rate is used for distinguishing the second area from the outside of the second area, it is possible to define an end of the second area depending on whether the packet signal from the base station apparatus may be received. Also, since the end of the second area is defined depending on whether the packet signal from the base station apparatus may be received, it is possible to widen the second area. Also, since the received power is used for distinguishing the first area from the second area, it is possible to define a range in which a propagation loss is within a predetermined degree as the first area. Since the range in which the propagation loss is within the predetermined degree is defined as the first area, it is possible to use the vicinity of the center of the intersection as the first area.

Also, since the received power is not used for distinguishing the second area from the outside of the second area and the error rate is not used for distinguishing the first area from the second area, it is possible to inhibit erroneous judgment. Also, since the priority period is used when the terminal apparatus is present in the first area and the general period is used when this is present in the second area, it is possible to decrease the collision probability between the packet signal from the terminal apparatus present in the first area and the packet signal from the terminal apparatus present in the second area. Also, since the time-division multiplexing by the slots is executed in the priority period, it is possible to decrease the error rate. Also, since the CSMA/CA is executed in the general period, it is possible to flexibly adjust the number of terminal apparatuses.

Also, since it is configured to adjust the length of the IP period by fixing the length of the IP period across a plurality of superframes without changing the same for each superframe, it is possible to allow the terminal apparatus to easily understand the length of the IP period. Also, since the terminal apparatus is allowed to easily understand the length of the IP period, it is possible to decrease the collision probability between the packet signal for the IP communication and the packet signal for the inter-vehicle communication. Also, since the change cycle of the length of the IP period is changed according to the amount of variation in the traffic amount, it is possible to set the change cycle suitable for the amount of variation. Also, the smaller the amount of variation in the traffic amount is, the longer the change cycle is made, so that it is possible to use the identical value for a long period of time as the length of the IP period. Also, the larger the amount of variation in the traffic amount is, the shorter the change cycle is made, so that the length of the IP period may be made a value suitable for the traffic amount.

The present invention is described above based on the embodiment. The embodiment is illustrative only and one skilled in the art may comprehend that various modified examples are possible in combination of the components and processes and that such modified examples also fall within the scope of the present invention.

In the embodiment of the present invention, the processing unit 26 adjusts the length of the IP period according to the traffic amount. However, this is not limitation and the processing unit 26 may adjust the length of the IP period according to another parameter, for example. The parameter includes a static parameter and a dynamic parameter. The static parameter is a value, which may be fixedly set in advance, such as a time zone and a day of week. On the other hand, the dynamic parameter is the traffic amount, the number of terminal apparatuses 14 in the first area 210 and the second area 212, and the collision probability of the packet signals. According to this modified example, it is possible to set the length of the IP period suitable for the status.

In the modified example of the present invention, the processing unit 26 adjusts the length of the IP period according to the average value of the traffic amount and determines the change cycle according to the amount of variation in the traffic amount. However, this is not limitation and the processing unit 26 may adjust the length of the IP period and determine the change cycle according to another parameter, for example. The parameter includes the static parameter and the dynamic parameter. The static parameter is the value, which may be fixedly set in advance, such as the time zone and the day of week. On the other hand, the dynamic parameter is the traffic amount, the number of terminal apparatuses 14 in the first area 210 and the second area 212, and the collision probability of the packet signals. According to this modified example, it is possible to set the length of the IP period and the change cycle suitable for the status.

In the embodiment and the modified example of the present invention, the IP communication is executed between the base station apparatus 10 and the terminal apparatus 14 in the IP period in FIGS. 3 to 7. Herein, the uplink IP period and the downlink IP period are collectively referred to as the IP periods. However, this is not limitation and the IP communication between the terminal apparatuses 14 may be performed in the IP period, for example. Meanwhile, when the uplink IP period and the downlink IP period are defined, the IP communication between the terminal apparatuses 14 may be performed in any one of them or the IP communication between the terminal apparatuses 14 may be performed in both of them. The configuration of the terminal apparatus 14 according to the modified example is of the type similar to that in FIG. 10. The control information extracting unit 66 receives information about the configuration of the superframe from the base station apparatus 10 as described above. The processing unit 56, the modem unit 54, and the RF unit 52 broadcast the packet signal in the inter-vehicle transmission period and execute the one-to-one IP communication with another terminal apparatus 14 in the IP period. According to this modified example, it is possible to execute the IP communication also between the vehicles while decreasing the effect on the inter-vehicle communication and the road-to-vehicle communication.

For example, a base station apparatus according to one aspect of the present invention is a base station apparatus, which controls inter-terminal communication, comprising: a generating unit configured to define a frame in which a first period in which the base station apparatus may broadcast a signal, a second period in which a terminal apparatus may broadcast the signal, and a third period in which one-to-one transmission of the signal between the base station apparatus and the terminal apparatus may be performed are time-division multiplexed and to generate information about a configuration of the frame; a broadcasting unit configured to broadcast the signal in which the information generated by the generating unit is included in the first period; a receiving unit configured to receive the signal broadcasted from the terminal apparatus in the second period; and a communicating unit configured to perform one-to-one communication with the terminal apparatus in the third period.

Another aspect of the present invention also is a base station apparatus. This apparatus is a base station apparatus, which controls inter-terminal communication, comprising: a generating unit configured to define a superframe in which a third period in which one-to-one transmission of a signal between the base station apparatus and a terminal apparatus may be performed is further time-division multiplexed after time-division multiplexing of a plurality of frames in each of which a first period in which the base station apparatus may broadcast the signal and a second period in which the terminal apparatus may broadcast the signal are time-division multiplexed and to generate information about a configuration of the superframe; a broadcasting unit configured to broadcast the signal in which the information generated by the generating unit is included in the first period of any one of a plurality of frames included in the superframe; a receiving unit configured to receive the signal broadcasted from the terminal apparatus in the second period; and a communicating unit configured to perform one-to-one communication with the terminal apparatus in the third period.

Still another aspect of the present invention also is a base station apparatus. This apparatus is a base station apparatus, which controls inter-terminal communication, comprising: a generating unit configured to define a frame in which a first period in which the base station apparatus may broadcast a signal, a second period in which a terminal apparatus may broadcast the signal, a third period in which one-to-one transmission of the signal from the base station apparatus to the terminal apparatus may be performed between the first and second periods, and a fourth period in which the one-to-one transmission of the signal from the terminal apparatus to the base station apparatus may be performed after the second period are time-division multiplexed and to generate information about a configuration of the frame; a broadcasting unit configured to broadcast the signal in which the information generated by the generating unit is included in the first period; a receiving unit configured to receive the signal broadcasted from the terminal apparatus in the second period; and a communicating unit configured to perform the one-to-one transmission of the signal to the terminal apparatus in the third period and performs one-to-one reception of the signal from the terminal apparatus in the fourth period.

Still another aspect of the present invention also is a base station apparatus. This apparatus is a base station apparatus, which controls inter-terminal communication, comprising: a generating unit configured to define a frame in which a first period in which the base station apparatus may broadcast a signal, a second period in which a terminal apparatus may broadcast the signal, and a third period in which one-to-one transmission of the signal between the base station apparatus and the terminal apparatus may be performed are time-division multiplexed and to generate information about a configuration of the frame; a broadcasting unit configured to broadcast the signal in which the information generated by the generating unit is included in the first period; a receiving unit configured to receive the signal broadcasted from the terminal apparatus in the second period; and a communicating unit configured to perform one-to-one communication with the terminal apparatus in the third period. The generating unit adjusts a length of the third period for each cycle across a plurality of frames.

Still another aspect of the present invention also is a base station apparatus. This apparatus is a base station apparatus, which controls inter-terminal communication, comprising: a generating unit configured to define a superframe in which a third period in which one-to-one transmission of a signal between the base station apparatus and a terminal apparatus may be performed is further time-division multiplexed after time-division multiplexing of a plurality of frames in each of which a first period in which the base station apparatus may broadcast the signal and a second period in which the terminal apparatus may broadcast the signal are time-division multiplexed and to generate information about a configuration of the superframe; a broadcasting unit configured to broadcast the signal in which the information generated by the generating unit is included in the first period of any one of a plurality of frames included in the superframe; a receiving unit configured to receive the signal broadcasted from the terminal apparatus in the second period; and a communicating unit configured to perform one-to-one communication with the terminal apparatus in the third period. The generating unit adjusts a length of the third period for each cycle across a plurality of superframes.

Still another aspect of the present invention also is a base station apparatus. This apparatus is a base station apparatus, which controls inter-terminal communication, comprising: a generating unit configured to define a frame in which a first period in which the base station apparatus may broadcast a signal, a second period in which a terminal apparatus may broadcast the signal, a third period in which one-to-one transmission of the signal from the base station apparatus to the terminal apparatus may be performed between the first and second periods, and a fourth period in which the one-to-one transmission of the signal from the terminal apparatus to the base station apparatus may be performed after the second period are time-division multiplexed and to generate information about a configuration of the frame; a broadcasting unit configured to broadcast the signal in which the information generated by the generating unit is included in the first period; a receiving unit configured to receive the signal broadcasted from the terminal apparatus in the second period; and a communicating unit configured to perform the one-to-one transmission of the signal to the terminal apparatus in the third period and performs one-to-one reception of the signal from the terminal apparatus in the fourth period. The generating unit adjusts at least one of a length of the third period and a length of the fourth period for each cycle across a plurality of frames.

Still another aspect of the present invention is a terminal apparatus. This apparatus is a terminal apparatus, which executes communication with a base station apparatus or communication between terminal apparatuses, comprising: a receiving unit configured to define a frame in which a first period in which the base station apparatus may broadcast a signal, a second period in which the terminal apparatus may broadcast the signal, and a third period in which one-to-one transmission of the signal between the terminal apparatuses may be performed are time-division multiplexed and to receive information about a configuration of the frame from the base station apparatus in the first period; a broadcasting unit configured to broadcast the signal in the second period; and a communicating unit configured to perform one-to-one communication with the base station apparatus or another terminal apparatus in the third period.

What is claimed is:

1. A base station apparatus, which controls inter-terminal communication, comprising:
a generating unit configured to define a frame in which a first period in which the base station apparatus may broadcast a signal, a second period in which a terminal apparatus may broadcast the signal, and a third period in which one-to-one transmission of the signal between the base station apparatus and the terminal apparatus may be performed are time-division multiplexed and to generate information about a configuration of the frame;
a broadcasting unit configured to broadcast the signal in which the information generated by the generating unit is included in the first period;
a receiving unit configured to receive the signal broadcasted from the terminal apparatus in the second period; and
a communicating unit configured to perform one-to-one communication with the terminal apparatus in the third period.

2. A base station apparatus, which controls inter-terminal communication, comprising:
a generating unit configured to define a superframe in which a third period in which one-to-one transmission of a signal between the base station apparatus and a terminal apparatus may be performed is further time-division multiplexed after time-division multiplexing of a plurality of frames in each of which a first period in which the base station apparatus may broadcast the signal and a second period in which the terminal apparatus may broadcast the signal are time-division multiplexed and to generate information about a configuration of the superframe;
a broadcasting unit configured to broadcast the signal in which the information generated by the generating unit is included in the first period of any one of a plurality of frames included in the superframe;
a receiving unit configured to receive the signal broadcasted from the terminal apparatus in the second period; and
a communicating unit configured to perform one-to-one communication with the terminal apparatus in the third period.

3. The base station apparatus according to claim 1, further comprising:
a measuring unit configured to measure a traffic amount in the second period, wherein the generating unit adjusts a length of the third period according to the traffic amount measured by the measuring unit.

4. The base station apparatus according to claim 1, wherein
the generating unit defines the frame in which the third period in which the one-to-one transmission of the signal from the base station apparatus to the terminal apparatus may be performed between the first period and the second period and a fourth period in which the one-to-one transmission of the signal from the terminal apparatus to the base station apparatus may be performed after the second period are time-division multiplexed, and
the communicating unit performs the one-to-one transmission of the signal to the terminal apparatus in the third period and performs one-to-one reception of the signal from the terminal apparatus in the fourth period.

5. The base station apparatus according to claim 4, further comprising:
a measuring unit configured to measure a traffic amount in the second period, wherein the generating unit adjusts at least one of a length of the third period and a length of the fourth period according to the traffic amount measured by the measuring unit.

6. The base station apparatus according to claim 1, wherein,
in the second period, a plurality of slots, each of which may be used by one terminal apparatus, are arranged and a period of a predetermined length, which may be shared by a plurality of terminal apparatuses, is arranged after a plurality of slots.

7. The base station apparatus according to claim 1, wherein
the generating unit adjusts a length of the third period for each cycle across a plurality of frames.

8. The base station apparatus according to claim 7, further comprising:
a measuring unit configured to measure a traffic amount in the second period, wherein
the generating unit determines the number of frames in which the length of the third period is fixed according to variation in the traffic amount measured by the measuring unit and adjusts the length of the third period according to the traffic amount measured by the measuring unit.

9. The base station apparatus according to claim 2, wherein
the generating unit adjusts a length of the third period for each cycle across a plurality of superframes.

10. The base station apparatus according to claim 9, further comprising:
a measuring unit configured to measure a traffic amount in the second period, wherein
the generating unit determines the number of superframes in which the length of the third period is fixed according to variation in the traffic amount measured by the measuring unit and adjusts the length of the third period according to the traffic amount measured by the measuring unit.

11. The base station apparatus according to claim 4, wherein
the generating unit adjusts at least one of a length of the third period and a length of the fourth period for each cycle across a plurality of frames.

12. The base station apparatus according to claim 11, further comprising:
a measuring unit configured to measure a traffic amount in the second period, wherein
the generating unit determines the number of frames in which at least one of the length of the third period and the length of the fourth period is fixed according to variation in the traffic amount measured by the measuring unit and adjusts at least one of the length of the third period and the length of the fourth period according to the traffic amount measured by the measuring unit.

13. A terminal apparatus, which executes communication with a base station apparatus or communication between terminal apparatuses, comprising:
a receiving unit configured to define a frame in which a first period in which the base station apparatus may broadcast a signal, a second period in which the terminal apparatus may broadcast the signal, and a third period in which one-to-one transmission of the signal between the terminal apparatuses may be performed are time-division multiplexed and to receive information about a configuration of the frame from the base station apparatus in the first period;
a broadcasting unit configured to broadcast the signal in the second period; and
a communicating unit configured to perform one-to-one communication with the base station apparatus or another terminal apparatus in the third period.
